(19) United States
(12) Patent Application Publication
(10) Pub. No.: US 2023/0002595 A1
(43) Pub. Date: Jan. 5, 2023

(54) FUNCTIONALIZED ELASTOMER BLEND FOR TIRE TREAD

(71) Applicant: The Goodyear Tire & Rubber Company, Akron, OH (US)

(72) Inventors: Nihat Ali Isitman, Hudson, OH (US); Teresa Diane Martter, Akron, OH (US)

(21) Appl. No.: 17/359,882

(22) Filed: Jun. 28, 2021

(51) Int. Cl. C08L 15/00; B60C 1/00

(52) U.S. Cl. CPC C08L 15/00; B60C 1/0016; C08L 2205/025

(57) ABSTRACT

A rubber compound for a tire tread includes more than a 30% maximum difference in styrene content between a pair of functionalized diene elastomers. At least one of the diene elastomers contains a functional group that can interact with a precipitated silica that is also in the composition.

### FIELD OF THE INVENTION

The present exemplary embodiments relate to a rubber composition comprising a greater than 30% maximum difference in styrene content by weight between any pair of rubber elastomers in the composition. It finds particular application in conjunction with tire treads and will be described with particular reference thereto. However, it is to be appreciated that the present exemplary embodiments are also amenable to other like applications.

### BACKGROUND OF THE INVENTION

In rubber compositions, functionalized polymers are highly desired to maximize tire performance. They are sometimes used to improve the affinity of a given rubbery polymer for filler reinforcements, such as carbon black or silica. These polymers are known to beneficially reduce rolling resistance and to improve the tread wear characteristics of tires. However, such improvements may be realized to the detriment of wet skid (or grip) resistance. In the tire industry, a large amount of technology is directed toward balancing these viscoelastically inconsistent properties. However, tradeoffs are typically accepted between properties to realize a desired performance characteristic.

A rubber compound is desired which displays an excellent tread wear, rolling resistance, and wet skid resistance.

### DETAILED DESCRIPTION OF THE INVENTION

One embodiment of the disclosure is directed to a sulfur curable rubber composition comprising, based on 100 parts by weight of elastomer (phr):

(A) at least two diene elastomers, a pair of the at least two diene elastomers being characterized by a greater than 30% maximum difference in styrene content by weight; and

(B) from about 60 to about 180 phr of a precipitated silica filler;

wherein at least one of the diene elastomers is functionalized to react with the silica.

In a further embodiment of the disclosure, the rubber composition is incorporated in a tire tread.

Another embodiment of the disclosure is directed to a sulfur curable rubber composition for incorporation in a tire tread. The rubber composition comprises, based on 100 parts by weight of elastomer (phr):

(A) a pair of elastomers present in an amount that totals 100 phr, the pair comprising:
(1) greater than about 50 phr of a solution polymerized styrene-butadiene rubber (s-SBR) functionalized to react with silica, and
(2) a polybutadiene rubber functionalized to react with silica;

wherein the pair is characterized by a greater than 30% maximum difference in styrene content by weight; and

(B) a precipitated silica filler.

The disclosed rubber composition comprises at least two diene-based elastomers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

The phrases “rubber” or “elastomer containing olefinic unsaturation” or “diene-based elastomer” are intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile, which polymerize with butadiene to form NBR, methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are polyisoprene (natural or synthetic), polybutadiene and SBR. In one embodiment, one elastomer in a pair is an SBR and the other elastomer in a pair is a polybutadiene rubber.

In one embodiment, at least one elastomer is a solution polymerized styrene-butadiene rubber (s-SBR).

In one aspect of this invention, an emulsion polymerization derived styrene/butadiene (E-SBR) might be used having a medium to relatively high bound styrene content, namely, a bound styrene content of greater than 30 percent, such as, as an example only, from about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S—SBR) typically has a bound styrene content in a range of about 9 to about 36 percent. However, in the preferred embodiment, an S—SBR has a bound styrene content of greater than 30 percent and, more preferably, greater than 34%.

The S—SBR can be conveniently prepared, for example, by organo lithium catalyzation in the presence of an organic hydrocarbon solvent.

In one embodiment, only one elastomer in a pair of the at least two diene elastomers are derived from styrene and butadiene. In one embodiment, cis 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

In one embodiment, at least one of a/each pair of diene elastomers is functionalized to react with the silica. In a preferred embodiment, each of the diene elastomers in a/each pair is functionalized to react with silica. In one embodiment, the rubber composition excludes nonfunctionalized rubber elastomers.

Representative of functionalized elastomers are, for example, styrene/butadiene elastomers containing one or more functional groups comprised of

(A) amine functional group reactive with hydroxyl groups on said precipitated silica,

(B) siloxy functional group, including end chain siloxy groups, reactive with hydroxyl groups on said precipitated silica,

(C) combination of amine and siloxy functional groups reactive with hydroxyl groups on said precipitated silica,

(D) combination of thiol and siloxy (e.g. ethoxysilane) functional groups reactive with hydroxyl groups on said precipitated silica,

(E) combination of imine and siloxy functional groups reactive with hydroxyl groups on said precipitated silica, and

(F) hydroxyl functional groups reactive with said precipitated silica.

For the functionalized elastomers, representative of amine functionalized SBR elastomers are, for example, in-chain functionalized SBR elastomers mentioned in U.S. Pat. No. 6,936,669.

Representative of a combination of amino-siloxy functionalized SBR elastomers with one or more amino-siloxy groups connected to the elastomer is, for example, HPR355™ from JSR and amino-siloxy functionalized SBR elastomers mentioned in U.S. Pat. No. 7,981,966.

Representative styrene/butadiene elastomers end functionalized with a silane-sulfide group are, for example, mentioned in U.S. Pat. Nos. 8,217,103 and 8,569,409.

Organic solvent polymerization prepared tin coupled elastomers such as for example, tin coupled styrene/butadiene copolymers may also be used.

Tin coupled copolymers of styrene/butadiene may be prepared, for example, by introducing a tin coupling agent during the styrene/1,3-butadiene monomer copolymerization reaction in an organic solvent solution, usually at or near the end of the polymerization reaction. Such coupling of styrene/butadiene copolymers is well known to those having skill in such art.

In practice, it is usually preferred that at least 50 percent and more generally in a range of about 60 to about 85 percent of the Sn (tin) bonds in the tin coupled elastomers are bonded to butadiene units of the styrene/butadiene copolymer to create Sn-dienyl bonds such as butadienyl bonds.

Creation of tin-dienyl bonds can be accomplished in a number of ways such as, for example, sequential addition of butadiene to the copolymerization system or use of modifiers to alter the styrene and/or butadiene reactivity ratios for the copolymerization. It is believed that such techniques, whether used with a batch or a continuous copolymerization system, is well known to those having skill in such art.

Various tin compounds, particularly organo tin compounds, may be used for the coupling of the elastomer. Representative of such compounds are, for example, alkyl tin trichloride, dialkyl tin dichloride, yielding variants of a tin coupled styrene/butadiene copolymer elastomer, although a trialkyl tin monochloride might be used which would yield simply a tin-terminated copolymer.

Examples of tin-modified, or coupled, styrene/butadiene copolymer elastomers might be found, for example and not intended to be limiting, in U.S. Pat. No. 5,064,901.

In one embodiment, a pair of the at least two diene elastomers are characterized by a greater than 30% maximum difference in styrene content by weight. In a preferred embodiment, each pair of the at least two diene elastomers are characterized by the greater than 30% maximum difference in styrene content by weight. Embodiments are contemplated where three or more diene elastomers are comprised in the rubber composition. In such embodiments, any pair of the at least two diene elastomers are characterized by the greater than 30% maximum difference in styrene content by weight. However, such embodiments may include a blend of functionalized and nonfunctionalized diene elastomers. In the preferred embodiment, any pair comprising at least one functionalized diene elastomer is characterized by the greater than 30% maximum difference in styrene content by weight. In a more preferred embodiment, all pairs of functionalized diene elastomers are characterized by the greater than 30% maximum difference in styrene content by weight.

In one embodiment, the disclosed rubber composition comprises as the diene elastomers, from about 40 to about 70 phr, and more preferably from about 50 to about 60 phr, of at least one styrene-butadiene rubber, with the remainder being at least a second diene elastomer for a combined total of 100 phr. In another embodiment, the disclosed rubber composition comprises as the diene elastomers, from about 30 to about 60 phr, and more preferably from about 40 to about 50 phr, of at least one polybutadiene rubber elastomer, with the remainder being made up of at least a second diene elastomer for a combined total of 100 phr.

In one embodiment, the disclosed rubber composition comprises as the diene elastomers, from about 50 to about 60 phr of a first diene elastomer and from about 40 to about 60 phr of a second diene elastomer for a combined total of 100 phr for the pair. In one embodiment, the rubber composition comprises an s-SBR for the majority portion of the total 100 phr and a polybutadiene for the minority portion of the total.

In one embodiment, the rubber composition may include from about 20 to about 200 phr of silica and, more preferably, from about 60 to about 180 phr. The commonly employed siliceous pigments which may be used in the rubber compound include conventional pyrogenic and precipitated siliceous pigments (silica). In one embodiment, precipitated silica is used. The conventional siliceous pigments employed in the disclosed rubber compound are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930), as well as ASTM D3037.

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Other fillers may be used in the rubber composition including, but not limited to, carbon black or particulate fillers including ultra-high molecular weight polyethylene (UHMWPE), crosslinked particulate polymer gels including, but not limited to, those disclosed in U.S. Pat. Nos. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment, the rubber composition may contain a conventional sulfur containing organosilicon compound. In one embodiment, the sulfur containing organosilicon compounds are 3,3′-bis(trimethoxy or triethoxy silylpropyl) polysulfides. In one embodiment, the sulfur containing organo silicon compounds are 3,3′-bis(triethoxysilylpropyl) disulfide and/or 3,3′-bis(triethoxysilylpropyl) tetrasulfide.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur-vulcanizing agent is elemental sulfur. The sulfur-vulcanizing agent may be used in an amount ranging from 0.5 to 8 phr, with a range of from 1 to 6 phr being preferred. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), pages 344 through 346. Typical amounts of antiozonants comprise about 1 to 5 phr. Typical amounts of fatty acids, if used, which can include stearic acid comprise about 0.5 to about 5 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 6, preferably about 0.8 to about 3, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a tread of a tire. The tire may be pneumatic or non-pneumatic.

The tire of the present invention may be a race tire, passenger tire, aircraft tire, agricultural, earthmover, off-the-road, truck tire, and the like. The tire may also be a radial or bias, with a radial being preferred.

Vulcanization of a pneumatic tire of the present invention would be generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following examples are presented for the purposes of illustrating and not limiting the present invention. All parts are parts by weight unless specifically identified otherwise.

### Example 1

In this example, the effects on the performance of rubber compounds are illustrated for compounds comprising varying degrees of difference in styrene content between any pair of diene elastomers in such compounds. In the samples, at least one diene elastomer contains functional groups that can interact with silica.

Rubber compounds were mixed in a multi-step mixing procedure following the recipes in Table 1. Standard amounts of additive materials and curing techniques were also used. The rubber compounds were then cured and tested for various properties including, inter alia, tread wear, wet skid resistance, rolling resistance, and winter (low temperature) performance.

A control rubber compound was prepared as Sample A using a single functionalized solution polymerized SBR. In control Sample A, the difference in styrene content is null because the diene elastomer—which is an s-SBR—is not paired with at least one additional diene elastomer in the rubber compound.

For control Samples B-D, the rubber compounds each comprise two diene rubber elastomers. The difference in the styrene content between each pair of rubber elastomers varies among the control Samples B-D. The difference in the styrene content increases across the control Samples B-D, but is below 30% for each pair.

Control Sample B was prepared using two functionalized solution polymerized SBRs. Control Samples C and D were each prepared with a solution polymerized SBR and the same polybutadiene rubber, with all other ingredients being the same. For control Sample C, the s-SBR was end functionalized with groups reactive with hydroxyl groups on precipitated silica. For control Sample D, the s-SBR was also functionalized to be reacted with precipitated silica. The polybutadiene rubber further contained functional groups that are reactive with hydroxyl groups on precipitated silica.

Control Sample E was prepared using a solution polymerized SBR and a solution polymerized polybutadiene. The difference in the styrene content by weight was greater than the difference for control Samples B-D, but neither one of the diene rubbers was functionalized.

For the experimental Samples F-H, rubber compounds were each prepared using varying amounts of the same two diene rubbers. The pair of diene elastomers included a solution polymerized SBR and a solution polymerized polybutadiene, the both of which were functionalized in each pair. The difference in the styrene content between each pair of rubber elastomers was greater than 30%.

The basic formulations are illustrated in the following Table 1, which is presented in parts per 100 parts by weight of elastomers (phr).

TABLE 1

| | | | Samples | | | | | | | |
|---|---|---|---|---|---|---|---|---|---|---|
| | | % | Control | | | | | Experimental | | |
| | Functionalized | Styrene | A | B | C | D | E | F | G | H |
| SBR¹ | No | 34 | | | | | 52 | | | |
| SBR² | Yes | 34 | | | | | | 52 | 56 | 60 |
| SBR³ | Yes | 15 | 100 | 30 | | | | | | |
| SBR⁴ | Yes | 21 | | 70 | 85 | | | | | |
| SBR⁵ | Yes | 27 | | | | 80 | | | | |
| BR⁶ | No | 0 | | | | | 48 | | | |
| BR⁷ | Yes | 0 | | | 15 | 20 | | 48 | 44 | 40 |

| | | | | | | | | |
|---|---|---|---|---|---|---|---|---|
| Difference in styrene % | 0 | 6 | 21 | 27 | 34 | 34 | 34 | 34 |
| Functionalization | Yes | Yes | Yes | Yes | No | Yes | Yes | Yes |

¹Solution polymerized SBR with styrene content of 34% and 1,2-vinyl content of 38%,
Tg = −24° C. extended with 37.5 phr TDAE oil, obtained as Tufdene E680 from Asahi Chemical.
²Solution polymerized SBR with styrene content of 34% and 1,2-vinyl content of 38%,
Tg = −21° C. extended with 25 phr TDAE oil, obtained from LG Chem as F3438.
³Solution polymerized SBR with styrene content of 15% and 1,2-vinyl content of 26%,
Tg = −60° C. obtained from Trinseo as Sprintan ® SLR 3402.
⁴Solution polymerized SBR with styrene content of 21% and 1,2-vinyl content of 50%,
Tg = −23° C. obtained from Trinseo as Sprintan ® SLR 4602.
⁵Solution polymerized SBR with styrene content of 27% and 1,2-vinyl content of 42%,
Tg = −22° C. obtained from Japan Synthetic Rubber (JSR) Corporation as HPR355HR.
⁶Solution polymerized polybutadiene copolymers obtained from Goodyear Chemical.
⁷Functionalized low vinyl (12 percent) solution polymerized polybutadiene rubber, obtained as BR1261 from Zeon having a Tg of about −90° C.

Various cured rubber properties of the control Samples A-E and the experimental Samples F-H are reported in the following Table 2.

TABLE 2

| | Samples | | | | | | | |
|---|---|---|---|---|---|---|---|---|
| | Control | | | | | Experimental | | |
| | A | B | C | D | E | F | G | H |
| Tread Wear/Abrasion | | | | | | | | |
| 300% Modulus, MPa | 7.9 | 8.5 | 8.8 | 9.1 | 8.9 | 9.5 | 10.1 | 9.9 |
| Tensile Strength, MPa | 20.7 | 17.4 | 19.0 | 16.8 | 19.0 | 18.6 | 19.9 | 18.8 |
| Elongation | 599 | 503 | 546 | 471 | 529 | 493 | 496 | 484 |
| DIN (lower is better) | 48 | 113 | 110 | 94 | 80 | 62 | 65 | 71 |
| Wet Grip Indicator | | | | | | | | |
| Tan D at 0° C. (higher | 0.27 | 0.51 | 0.53 | 0.55 | 0.58 | 0.53 | 0.57 | 0.60 |
| the better) | | | | | | | | |
| Rolling Resistance | | | | | | | | |
| Tan D at 30° C. (lower | 0.18 | 0.19 | 0.20 | 0.19 | 0.27 | 0.20 | 0.20 | 0.20 |
| the better) | | | | | | | | |
| Winter Performance | | | | | | | | |
| G′ −20° C. (lower the | 8 | 29 | 36 | 38 | 54 | 35 | 38 | 45 |
| better) | | | | | | | | |

As can be seen in Table 2, the overall performance properties of the rubber compounds F-H (utilizing >30% maximum difference in styrene content between a pair of functionalized rubber elastomers in the compositions) compared favorably with the performance properties of the control Samples A-E.

Control Sample A—using a single functionalized solution polymerized SBR—indicated a favorable performance relating to predicted tread wear (aka tread life), and winter performance and rolling resistance. However, control Sample A indicated a significantly poor performance relating to predicted wet skid resistance (aka wet weather grip).

For control Samples B-D—using increasing differences (each being <30%) in styrene content between pairs of functionalized elastomers—a significant improvement is observed for predicted wet skid resistance (0.51-0.55, respectively) over control Sample A (which has a value of 0.27). Further, control Samples B-D do not necessitate a tradeoff between the improved wet skid resistance and the predicted rolling resistance of such compounds. The rolling resistance (0.19, 0.20, and 0.19 respectively) of control Samples B-D is similar to or slightly better than the rolling resistance (0.18) of control Sample A. However, a substantial decrease is observed for predicted tread wear performance. For example, the abrasion value of control Sample A is 48, while the values for control Samples B-D are 113, 110, and 94 respectively. Yet, these values gradually improve as the difference in styrene content increases (from 6% to 21% to 27%, respectively) between the pairs of functionalized elastomers. Therefore, a gradual improvement is observed for tread wear performance as the difference in styrene content increases between pairs of elastomers.

For control Sample E—using a non-functionalized s-SBR and a non-functionalized polybutadiene—the performance properties deteriorate over those of the inventive Samples F-H. Although the difference in the styrene content (>30%) between the elastomer pairs is about the same as experimental Samples F-H, it is believed that the absence of functional groups reactive to silica on the elastomers of control Sample E contributes to the poor performance.

A significant improvement in predicted performance is observed for the experimental Samples F-H, which each comprise a >30% maximum difference in styrene content between a pair of functionalized rubber elastomers in the composition. The following observations were made for the experimental Samples F-H over control Samples B-D having <30% maximum difference in styrene content between elastomer pairs: (1) a significantly improved abrasion resistance; (2) a slightly improved or similar predicted wet skid resistance; (3) a similar predicted rolling resistance; and (4) an acceptable predicted snow performance.

DIN abrasion, which is a measurement of compound abradibility, shows significantly lower values (62, 65, 71, respectively) for experimental Samples F-H. This indicates that experimental Samples F-H provide better wear resistance, i.e., improved tread wear. Control samples B-D have much higher values (113, 110, and 94, respectively), which indicates a lower resistance to abrasion.

Higher tan delta values at 0° C. are indicative of better traction characteristics. The wet indicator values for experimental Samples F-H are 0.53, 0.57 and 0.60, respectively, which is slightly improved and/or similar to the predicted wet indicator values (0.51, 0.53, and 0.55) of control Samples B-D.

The tan delta values at 30° C. are indicative of hysteresis and, generally, a lower hysteresis corresponds to a better or improved rolling resistance. The predicted rolling resistance values for experimental Samples F-H are 0.20, which is the same and/or similar to the predicted rolling resistance (0.19 or 0.20) of Samples B-D. This indicates that the rolling resistance approaches control Sample A, is maintained over control Samples B-D, and is significantly improved over control Sample E.

The winter properties for experimental Samples F-H were significantly improved over control Sample E as evidenced by a reduced storage moduli G′ at −20° C. The winter (low temperature) properties for the experimental Samples F-H approach control Samples B-D.

Below, Table 3 summarizes the results discussed supra.

TABLE 3

| | | Performance Characteristics | | | |
|---|---|---|---|---|---|
| | | | Rolling | Wet Skid | Winter Snow |
| | | Tread Wear | Resistance | Resistance | Performance |
| Ctl | A | Excellent | Excellent | Low | Excellent |
| | B | Decreased over A | Maintained over | Improved over A | Decreased over A |
| | | | A | | |
| | C | Decreased over A | Maintained over | Improved over A | Decreased over A |
| | | | A | | |
| | D | Decreased over A | Maintained over | Improved over A | Decreased over A |
| | | | A | | |
| | E | Worsened over F- | Worsened over F- | | Worsened over F- |
| | | H | H | | H |
| | F | Improved over B- | Approaches | Same or slightly | Approaches |
| | | D | and/or same as A- | improved over B- | and/or same as A- |
| | | | D | D | D |
| Exp'l | G | Improved over B- | Approaches | Same or slightly | Approaches |
| | | D | and/or same as A- | improved over B- | and/or same as A- |
| | | | D | D | D |
| | H | Improved over B- | Approaches | Same or slightly | Approaches |
| | | D | and/or same as A- | improved over B- | and/or same as A- |
| | | | D | D | D |
| Concluded: | | Advantage over | Similar/Acceptable | Similar/Improved | Similar/Acceptable |
| | | B-E | | | |

Therefore, a significant advantage is observed in the predicted tread wear performance of the inventive compounds over the control compounds that comprise at least two diene elastomers. Also, a slight advantage is observed in the predicted rolling resistance of the inventive compounds over the control compounds that comprise at least two diene elastomers. An acceptable balance is also maintained between wet skid resistance and winter performance.

It is hereby concluded that the presently disclosed rubber compounds are useful for tire treads when such compounds comprise more than a 30% maximum difference in styrene content between a pair of functionalized rubber elastomers, which are both reactive to silica.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A sulfur curable rubber composition comprising, based on 100 parts by weight of elastomer (phr):
(A) at least two diene elastomers, a pair of the at least two diene elastomers being characterized by a greater than 30% maximum difference in styrene content by weight; and
(B) from about 60 to about 180 phr of a precipitated silica filler;
wherein at least one of the diene elastomers is functionalized to react with the silica.

2. The sulfur curable rubber composition of claim 1, wherein all elastomers in the rubber composition are functionalized to react with silica.

3. The sulfur curable rubber composition of claim 1, wherein the rubber composition is characterized by a greater than 30% maximum difference in styrene content between every pair of the at least two elastomers in the composition.

4. The sulfur curable rubber composition of claim 1, wherein at least one elastomer is a functionalized polybutadiene rubber.

5. The sulfur curable rubber composition of claim 1, wherein at least one elastomer is a solution polymerized styrene-butadiene rubber (s-SBR).

6. The sulfur curable rubber composition of claim 1, wherein the s-SBR has a styrene content equal to or greater than about 30%.

7. The sulfur curable rubber composition of claim 1, wherein the s-SBR is tin or silicon coupled.

8. The sulfur curable rubber composition of claim 1, wherein the rubber composition excludes nonfunctionalized rubber elastomers.

9. The sulfur curable rubber composition of claim 1, wherein the at least two elastomers are present in amounts that total 100 phr.

10. The sulfur curable rubber composition of claim 9, wherein the at least two elastomers comprise:
a functionalized solution polymerized styrene-butadiene rubber (s-SBR) being present in an amount greater than 50 phr; and
a functionalized polybutadiene being present in an amount making up a remainder of the total.

11. The sulfur curable rubber composition of claim 10, wherein the amount of the s-SBR is from about 50 to about 60 phr.

12. The sulfur curable rubber composition of claim 10, wherein the amount of the polybutadiene is from about 40 to about 50 phr.

13. The sulfur curable rubber composition of claim 1, wherein the rubber composition is incorporated in a tire tread.

14. The sulfur curable rubber composition of claim 1, wherein the rubber composition is characterized by a higher resistance to abrasion compared to a control as measured by DIN abrasion, wherein the control comprises less than a 30% maximum difference in styrene content between pairs of functionalized rubber elastomers.

15. The sulfur curable rubber composition of claim 1, wherein the rubber composition is characterized by similar or improved wet skid resistance compared to a control as measured by tan delta at 0° C., wherein the control comprises less than a 30% maximum difference in styrene content between pairs of functionalized rubber elastomers.

16. The sulfur curable rubber composition of claim 1, wherein the rubber composition is characterized by similar or improved rolling resistance compared to a control as measured by tan delta at 30° C., wherein the control comprises less than a 30% maximum difference in styrene content between pairs of functionalized rubber elastomers.

17. The sulfur curable rubber composition of claim 1, wherein only one elastomer in a pair of the at least two diene elastomers is derived from styrene and butadiene.

18. A sulfur curable rubber composition for incorporation in a tire tread, the rubber composition comprising, based on 100 parts by weight of elastomer (phr):
(A) a pair of elastomers present in an amount that totals 100 phr, the pair comprising:
(1) greater than about 50 phr of a solution polymerized styrene-butadiene rubber (s-SBR) functionalized to reach with silica, and
(2) a polybutadiene rubber functionalized to react with silica;
wherein the pair is characterized by a greater than 30% maximum difference in styrene content by weight; and
(B) a precipitated silica filler.

19. The sulfur curable rubber composition of claim 18, wherein the silica is from about 60 to about 180 phr.

20. The sulfur curable rubber composition of claim 18, wherein, when compared to a control comprising less than a 30% maximum difference in styrene content between pairs of functionalized rubber elastomers, the rubber composition is characterized by a property selected from a group consisting:
a higher resistance to abrasion as measured by DIN abrasion;
an improved wet skid resistance as measured by tan delta at 0° C.;
an improved rolling resistance as measured by tan delta at 30° C.; and
a combination of the above;
with all other properties being similar or the same.
